(19) United States
(12) Patent Application Publication
(10) Pub. No.: US 2018/0133762 A1
(43) Pub. Date: May 17, 2018

(54) FLUID CLEAN APPARATUS

(71) Applicant: DINAMEC SYSTEMS, LLC, Acworth, GA (US)

(72) Inventors: Paul VERMEULEN, Gent (BE); Luc CEYSSENS, Augusta, GA (US)

(21) Appl. No.: 15/809,796

(22) Filed: Nov. 10, 2017

Related U.S. Application Data
(60) Provisional application No. 62/422,712, filed on Nov. 16, 2016.

(51) Int. Cl. B08B 7/00; B24B 31/00

(52) U.S. Cl. CPC B08B 7/0078; B08B 2220/01; B24B 31/003

(57) ABSTRACT

A fluid clean apparatus includes a container that has an opening for loading metal parts therein, and an internal loading platform system that includes a platform that is positioned inside the container, and a lift cylinder that is coupled to the platform and raises up and down the platform.

### CROSS REFERENCE TO RELATED APPLICATIONS

This application claims the benefit of U.S. provisional application entitled, “FLUID CLEAN APPARATUS,” having Ser. No. 62/422,712, filed on Nov. 16, 2016, which is entirely incorporated herein by reference.

### TECHNICAL FIELD

The present disclosure is generally related to thermal cleaning and, more particularly, is related to systems and methods for fluidized sandbed thermal & mechanical cleaning.

### BACKGROUND

Traditional cleaning of metal components that are adhered with paint, powder coating, plastic, polyesters, rubber, and other similar substances takes long periods of time, cause deformation or damage, and have a high operating cost.

Desirable in the art is an improved cleaning method and apparatus that would improve upon the conventional cleaning method and apparatus.

### SUMMARY

Fluid clean apparatuses are provided. A representative fluid clean apparatus includes a container that has an opening for loading metal parts therein, and an internal loading platform system that includes a platform that is positioned inside the container, and a lift cylinder that is coupled to the platform and raises up and down the platform.

Other systems, devices, methods, features of the invention will be or will become apparent to one skilled in the art upon examination of the following figures and detailed description. It is intended that all such systems, devices, methods, features be included within the scope of the invention, and be protected by the accompanying claims.

### BRIEF DESCRIPTION OF DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, the reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a perspective view that illustrates an embodiment of a fluid clean apparatus;

FIG. 2 is a perspective view of an internal loading platform,such as that shown in FIG. 1;

FIG. 3 is a perspective view that illustrates an embodiment of a fluid clean apparatus having a front door that is shown closed;

FIG. 4 is a side view that illustrates an embodiment of a fluid clean apparatus having a front door that is shown closed;

FIG. 5 is a perspective view that illustrates an embodiment of a fluid clean apparatus having a hoisting equipment;

FIG. 6 is a perspective view that illustrates an embodiment of a fluid clean apparatus having a front and top opening that can be covered by a hood;

FIG. 7 is a side view that illustrates an embodiment of a fluid clean apparatus having a front and top opening that can be covered by a hood; and

FIG. 8 is a high-level flow diagram that illustrates an embodiment of the architecture, functionality, and/or operation of fluid clean apparatus, such as that shown in FIG. 1.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams f the systems are provided to explain the manner in which metal parts are cleaned using fluidized sandbed thermal cleaning.

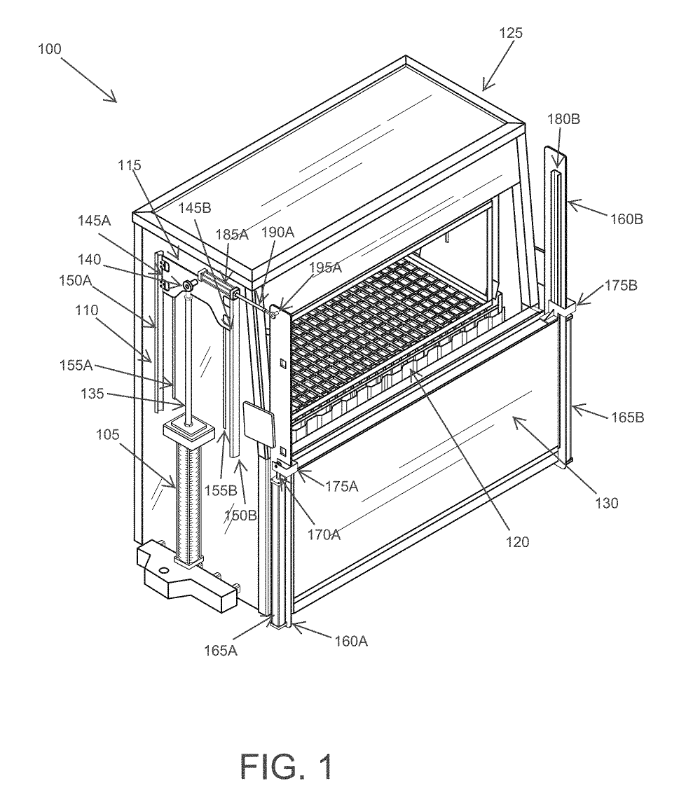

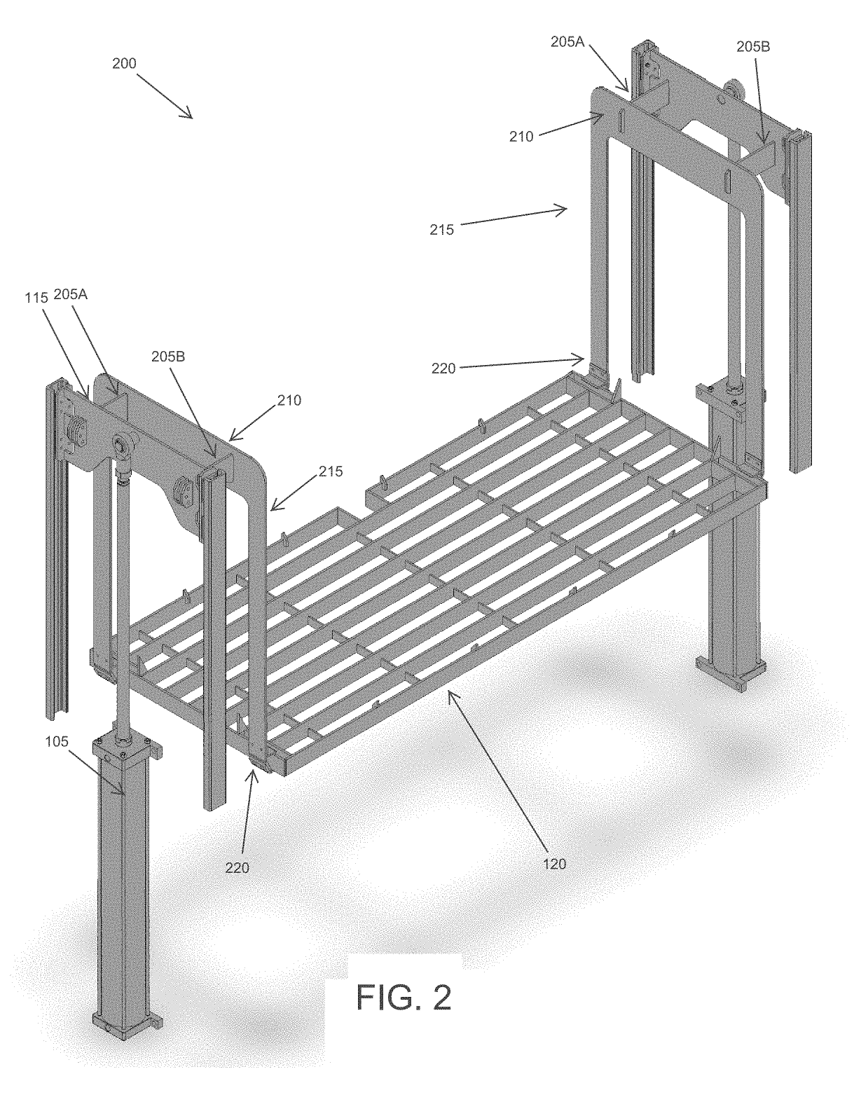

FIG. 1 is a perspective view that illustrates an embodiment of a fluid clean apparatus 100. In this example, the fluid clean apparatus 100 includes a front door 130 and a container 125 having a rear wall, right and left side walls, and a front wall with a top open portion that can be covered with the front door 130. The fluid clean apparatus 100 includes an internal loading platform system 200 (FIG. 2) that includes a lift cylinder 105, a platform truck track 110, a platform truck 115, and a platform 120.

The lift cylinder 105 is coupled to the platform truck 115 via a rod 135 that can be moved in and out (raised down and up) of the lift cylinder 105. The lift cylinder 105 can use a hydraulic or electro-mechanical mechanism or an air mechanism, or other similar mechanisms, to accomplish moving the rod 135 in and out of the cylinder 105. The rod 135 is coupled to the platform truck 115 at a distal end 140 of the rod 135.

The platform truck 115 slides along a platform truck track 110 and slots 155A, B of the side wall of the container 125. Specifically, the platform truck 115 includes a left edge 145A and a right edge 145B that are coupled to a left track 150A and a right track 150B of the platform truck track 110, respectively. The lift cylinder 105, platform truck track 110, and an outside portion of platform truck 115 is position outside of the container 125.

An inside portion of the platform truck 115 is coupled to the platform 120, which is position insider the container 125. As the platform 120 is raised up and side the container 125, the platform truck 115 is supported by the platform truck track 150A, B. FIG. 1 shows the left side of the internal loading platform system 200 and it should be noted that the right side of the internal loading platform system 200 is the same as the left side. This is shown in FIG. 2 and as such the internal loading platform system 200 is further shown and described in more detail in FIG. 2.

The front door 130 is coupled to vertical structures 160A, B and is raised up and down along the vertical structures 160A, B. Door lift cylinders 165A, B are coupled to the front door 130 via rods 170A, B and door couplings 175A, B that can be moved in and out (raised down and up) of the door lift cylinders 165A, B, opening and closing the opening of the container 125. The door lift cylinders 165A, B can use a hydraulic or electro-mechanical mechanism or an air mechanism, or other similar mechanisms, to accomplish moving the rod 170A, B in and out of the door cylinders 165A, B. The rods 170A, B are attached to the door couplings 175A, B, which are attached to the door 130. The door 130 slides along door truck tracks 180A, b that are attached to the vertical structures 160A, B.

Door cylinders 185A, B are positioned near the top of the side walls of the container. The door cylinders 185A, B are coupled to the distal end 195A of the vertical structures 160A, B via rods 190A, B that can be moved in and out of the door cylinders 185A, B, moving the front door 130 adjacent and afar from the opening of the container. The door cylinders 185A, B can use a hydraulic or electro-mechanical mechanism or an air mechanism, or other similar mechanisms, to accomplish moving the rod 190A, B in and out of the door cylinders 185A, B.

FIG. 2 is a perspective view of an internal loading platform system 200, such as that shown in FIG. 1. In this example, the architecture of the internal loading platform system 200 of FIG. 2 is similar to the architecture of the internal loading platform system 200 as described in FIG. 1. Like features are labeled with the same reference numbers, such as the lift cylinder 105, platform truck track 110, platform truck 115, and platform 120. The internal loading platform system 200 in FIG. 2 further includes extension structures 205A, B that connects the outside platform truck 115 to a top portion 210 of an inside platform truck 215. A bottom portion 220 of the inside platform truck 215 is coupled to the platform 120.

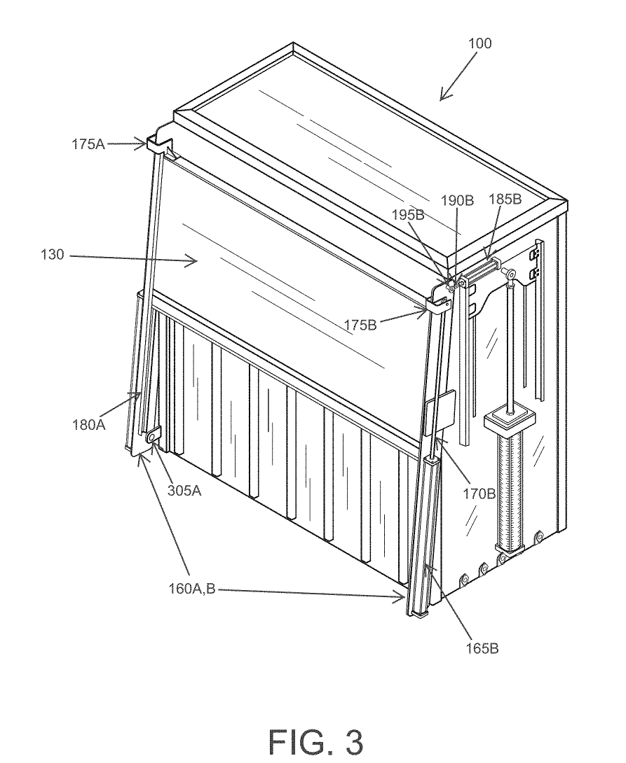

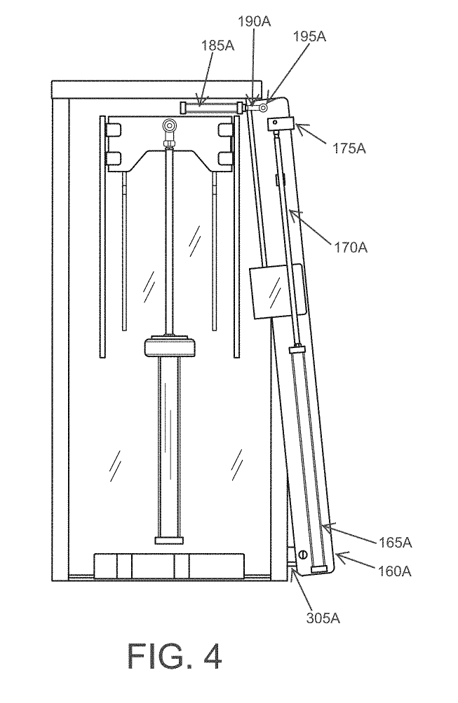

FIG. 3 is a perspective view that illustrates an embodiment of a fluid clean apparatus 100 having a front door 130 that is shown closed. FIG. 3 is a perspective view of the embodiment of a fluid clean apparatus 100, such as that shown in FIG. 2. In this example, the architecture of the front door 130 of FIG. 3 is similar to the architecture of the front door 130 as described in FIG. 2. Like features are labeled with the same reference numbers, such as the vertical structures 160A, B, lift cylinders 165A, B, door truck track 180A, B, and door cylinders 185A, B. The door 130 in FIG. 3 further includes structure couplings 305A, B that connect the container 100 to the proximal end of the vertical structure 160A, B. FIG. 4 is a side view that illustrates an embodiment of the fluid clean apparatus 100 having the front door that is shown closed.

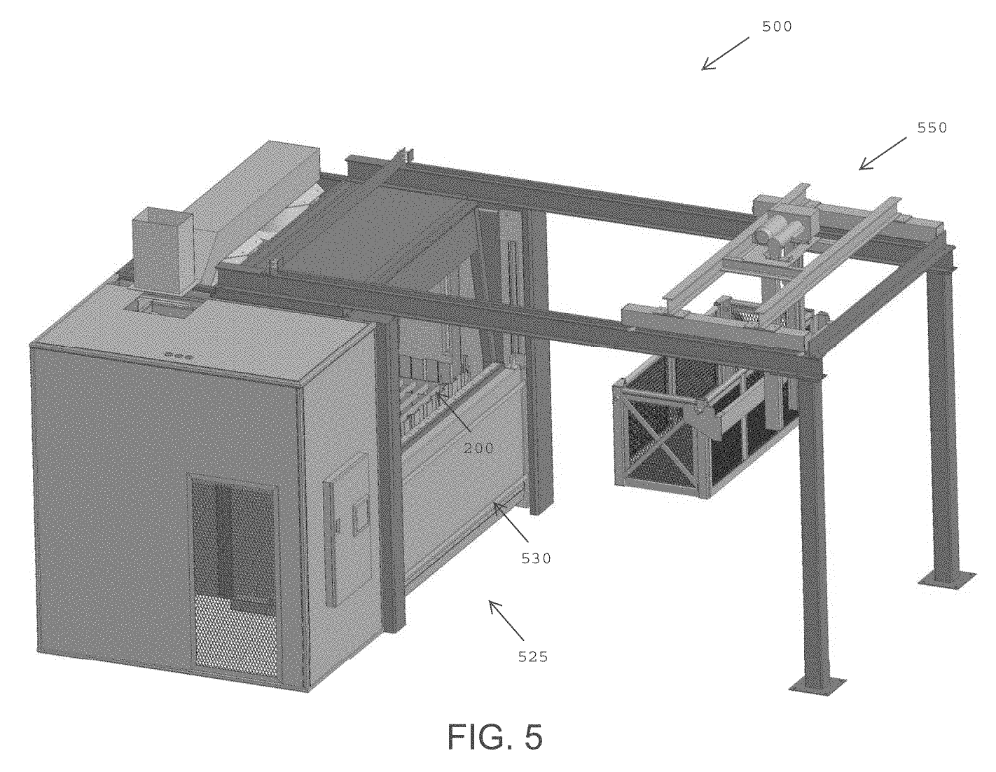

FIG. 5 is a perspective view that illustrates an embodiment of a fluid clean apparatus 500 having a hoisting equipment 550. In this example, the architecture of the fluid clean apparatus 500 of FIG. 5 is similar to the architecture of the fluid clean apparatus 100 as described in FIG. 1. The fluid clean apparatus 500 further includes a hoisting equipment 550 that can load a basket onto the internal loading platform 200 while the door 530 is opened in front of the container 525. The hoisting equipment 550 can be a gantry crane.

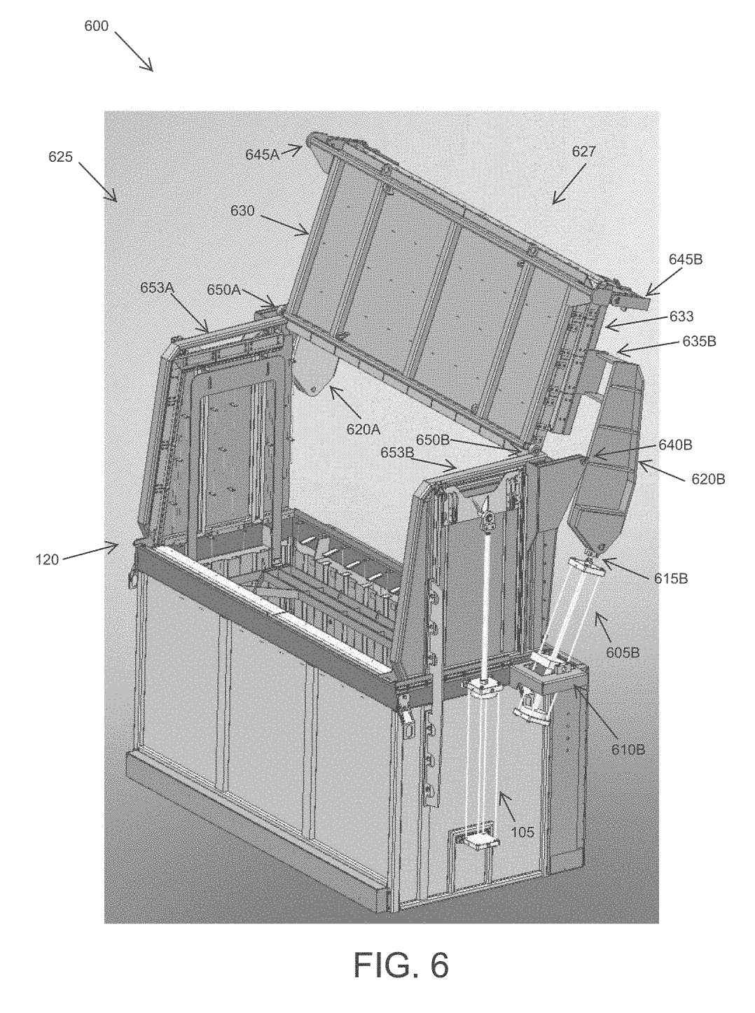

FIG. 6 is a perspective view that illustrates an embodiment of a fluid clean apparatus 600 having a front and top opening that can be covered by a hood 627. In this example, the architecture of the internal loading platform system 200 of FIG. 2 is similar to the architecture of the internal loading platform system 200 as described in FIG. 1. Like features are labeled with the same reference numbers, such as the lift cylinder 105, platform truck track 110, platform truck 115, and platform 120.

The container 625 has a front and top opening that can be covered by a hood 627. The hood 627 includes a front cover 630 and a top cover 633 that is mechanically hinged at 645A, B. The bottom left and right corner of the front cover 630 are attached with rollers 650A, B that roll on roller tracks 653A, B. The tracks 653A, B are positioned on the top and front edge of the left and side walls of the container 625.

The left edge and right edge of the top cover 633 are attached to at a distal end of the lever structures 620A,B. The proximal end of the lever structures 620A,B are attached to rods 615A,B of the lift cylinders 605A,B. The middle section of the lever structures 620A, B are attached to fulcrum structures 640A,B. Lift cylinders 605A,B are attached to cylinder locks 610A, B on the side walls of the container 625. As the cylinders 605A,B pull the lever structures 620A,B toward the cylinders 605A,B, the lever structures 620A,B pivots on the fulcrums 640A,B and pulls the top cover 633 upward and towards the rear of the container 625. This motion of the top cover 633 causes the front cover 630 to lift upward and move towards the rear of the container 625.

To close the hood 627, the cylinders 605A,B push the lever structures 620A, B away from the cylinders 605A,B. The lever structures 620A, B pivots on the fulcrums 640A,B and forces the top cover 633to move towards the front of the container and lowers the top cover 633 on the top edge of the container 625. This motion of the top cover 633 causes the front cover 630 and the rollers 650A,B to move along the roller tracks 653A,B towards the front and bottom of the container 625.

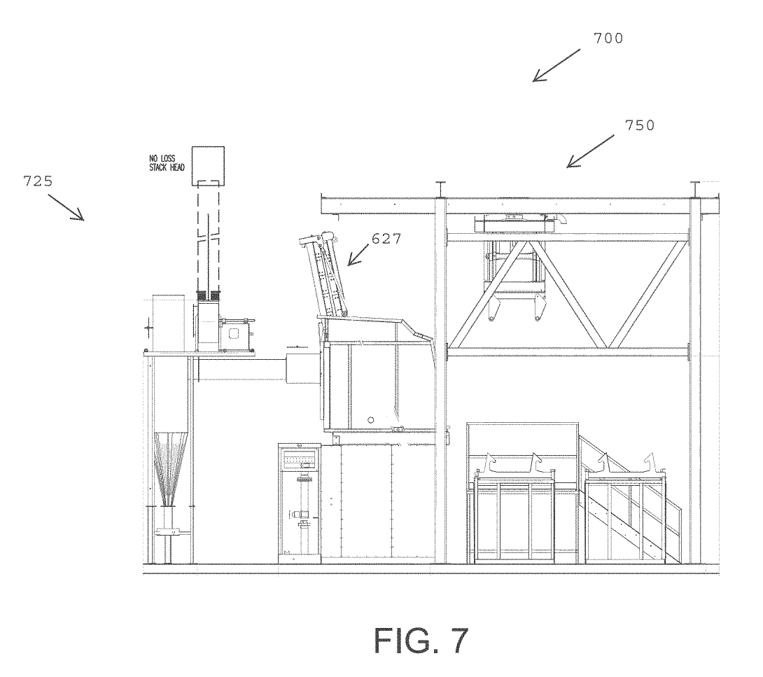

FIG. 7 is a side view that illustrates an embodiment of a fluid clean apparatus 700 having a front and top opening that can be covered by a hood 627. The fluid clean apparatus 700 further includes a hoisting equipment 750 that can load a basket onto the internal loading platform 200 while the hood 627 is opened at the top and front of the container 525. The hoisting equipment 750 can be a gantry crane.

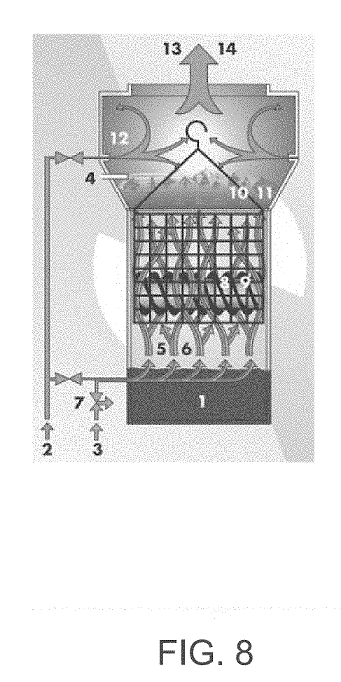

FIG. 8 is a high-level flow diagram that illustrates an embodiment of the architecture, functionality, and/or operation of fluid clean apparatus 100, such as that shown in FIG. 1. The fluid clean apparatus 100 includes a fluidized bed that can be filled with calibrated quartz sand with reference to state 1. At state 2, the sand particles are brought to a bubbling state by injecting air at the bottom of the fluidized bed. At state 3, gas is mixed into the primary air to warm up the sand.

At state 4, a pilot burner above the surface of the bubbling sand bed ignites the gas-air mixture, resulting in flames that spread across the surface. At states 5 and 6, the fluidized bed is heated quickly and uniformly and the normal operating temperature in the fluidized bed is around 780 to 850 degrees Fahrenheit. At state 8, the internal loading platform system 200 (FIG. 2) is lowered into the fluidized bed to immerse contaminated metal parts in the hot sand.

At states 9 and 10, bonded organic substances on the contaminated metal parts are gasified and gases rise through the fluidized bed and are directly burned by a flame-shield. At state 11, the sand particles absorb the heat from the flames and the external gas supply is correspondingly reduced. At state 12, gases in the fluidized bed are burned out by injecting secondary air into the fluidized bed.

At state 13, inorganic particles are also removed from the metal parts (without damage) by slight movement of the sand and are carried along with a flue gas stream. At state 14, the removed inorganic particles are referred to inert dust particles and these inert dust particles are separated from the flue gases by de-dusting through a cyclone battery or ceramic filter. The particles fall in to a collector reservoir under the cyclone or ceramic filter and can easily be removed.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as are suited to the particular use contemplated. All such modifications and variation are within the scope of this disclosure, as determined by the appended claims when interpreted in accordance with the breadth to which they are fairly and legally entitled.

1. A fluid clean apparatus comprising:
a container that has an opening for loading metal parts therein; and
an internal loading platform system that includes:
a platform that is positioned inside the container, and
a lift cylinder that is coupled to the platform and raises up and down the platform.

2. The fluid clean apparatus as defined in claim 1, wherein the internal loading platform system further includes a platform truck that is coupled to the lift: cylinder via a rod, wherein the lift cylinder uses a hydraulic or electro-mechanical mechanism or an air mechanism to accomplish moving the rod in and out of the lift cylinder.

3. The fluid clean apparatus as defined in claim 2, wherein the platform truck slides along a platform truck track and slots of a side wall of the container.

4. The fluid clean apparatus as defined in claim 3, wherein the platform truck includes a left edge and a right edge that are coupled to a left track and a right track of the platform truck track, respectively.

5. The fluid clean apparatus as defined in claim 1, further comprising a front door that covers the opening of the container.

6. The fluid clean apparatus as defined in claim 5, wherein the front door is raised up and down by a door lift cylinder.

7. The fluid clean apparatus as defined in claim 5, wherein the front door is coupled to vertical structures and is raised up and down along the vertical structure.

8. The fluid clean apparatus as defined in claim 7, wherein the door slides along door truck tracks that are attached to the vertical structures.

9. The fluid clean apparatus as defined in claim 7, wherein a door cylinder is coupled to the distal end of the vertical structures via a rod that is moved in and out of the door cylinder, moving the front door adjacent and afar from the opening of the container.

10. A fluid clean apparatus comprising:
a container that has an opening for loading metal parts therein;
a front door that covers the opening of the container; and
an internal loading platform system that includes:
a platform that is positioned inside the container, and
a lift cylinder that is coupled to the platform and raises up and down the platform.

11. The fluid clean apparatus as defined in claim 10, wherein the internal loading platform system further includes a platform truck that is coupled to the lift cylinder via a rod, wherein the lift cylinder uses a hydraulic or electro-mechanical mechanism or an air mechanism to accomplish moving the rod in and out of the lift cylinder.

12. The fluid clean apparatus as defined in claim 11, wherein the platform truck slides along a platform truck track and slots of a side wall of the container.

13. The fluid clean apparatus as defined in claim 12, wherein the platform truck includes a left edge and a right edge that are coupled to a left track and a right track of the platform truck track, respectively.

14. The fluid clean apparatus as defined in claim 10, further comprising a front door that covers the opening of the container.

15. The fluid clean apparatus as defined in claim 14, wherein the front door is raised up and down by a door lift cylinder.

16. The fluid clean apparatus as defined in claim 14, wherein the front door is coupled to vertical structures and is raised up and down along vertical structures.

17. The fluid clean apparatus as defined in claim 16, wherein the door slides along door truck tracks that are attached to the vertical structures.

18. The fluid clean apparatus as defined in claim 16, wherein a door cylinder is coupled to the distal end of the vertical structures via a rod that is moved in and out of the door cylinder, moving the front door adjacent and afar from the opening of the container.

19. A fluid clean apparatus comprising:
a container that has an opening for loading metal parts therein; and
an internal loading platform system that includes:
a platform that is positioned inside the container,
a lift cylinder that is coupled to the platform and raises up and down the platform,
a platform truck that is coupled to the lift cylinder via a rod,
wherein the lift cylinder uses a hydraulic or electro-mechanical mechanism or an air mechanism to accomplish moving the rod in and out of the lift cylinder, wherein the platform truck slides along a platform truck track and slots of a side wall of the container.

20. The fluid clean apparatus as defined in claim 19, wherein the platform truck includes a left edge and a right edge that are coupled to a left track and a right track of the platform truck track, respectively.
